(19) United States
(12) Patent Application Publication
(10) Pub. No.: US 2008/0210916 A1
(43) Pub. Date: Sep. 4, 2008

(54) TOOL FOR SEPARATING LADDER SECTIONS

(76) Inventor: Ronald L. Berkbuegler, Troy, IL (US)

Correspondence Address: SENNIGER POWERS LLP, ONE METROPOLITAN SQUARE, 16TH FLOOR, ST LOUIS, MO, 63102, US

(21) Appl. No.: 12/039,525

(22) Filed: Feb. 28, 2008

Related U.S. Application Data
(60) Provisional application No. 60/892,489, filed on Mar. 1, 2007.

(51) Int. Cl. E06C 1/00; B66F 15/00

(52) U.S. Cl. 254/131; 254/129; 182/129

(57) ABSTRACT

A separating tool includes a lever component and a linear-output component pivotally secured to the lever component. Each of the lever component and the linear-output component includes a rung-engagement member. The lever component and the linear-output component are configured so that when the rung-engagement members are engaging rungs of respective ladder sections, pivoting the lever component toward the linear output member imparts a linear force through the rung-engagement members that separates the ladder sections.

### FIELD OF THE INVENTION

The present invention generally relates to a separating tool for separating ladder sections.

### BACKGROUND OF THE INVENTION

Portable ladders, such as those used for ladder stands to hunt game at an elevated level, may include separate ladder sections that are removably secured together a friction-fit, press-fit or a like connection. The ladder sections include a stile segment and one or more rungs. The ladder is assembled by securing the stiles of one ladder section to the stiles of an adjacent ladder section. For example, the stiles may be secured together by inserting free ends of stiles of one section into open free ends of stiles of another section. For example, the respective ends of the stiles that are inserted into the other respective ends may be tapered (e.g., swaged).

A ladder with a friction-fit or a like connection for securing the ladder sections together is both easy to manufacture and easy to assemble. However, a drawback of such an arrangement is that it is difficult to disassemble the ladder by hand. That is, it is difficult to separate the ladder sections by merely trying to pull the sections apart manually. Moreover, it is likely that ice and other debris may become lodged at the connection site, making it even more difficult to separate the sections. It has been found that some users will use a hammer or other device to “beat” against a rung of one of the ladder sections in an attempt to force the sections apart. Such a method, however, is likely to damage the ladder and may even make the connection stronger if the rung adjacent to the connection site is bent.

### SUMMARY

In one aspect, a separating tool generally comprises a generally rigid, elongate lever component having a longitudinal axis and opposite longitudinal end margins. The lever component includes a rung-engagement member at one of the longitudinal end margins of the lever component and a handle generally adjacent to the other longitudinal end margin of the lever component. The rung-engagement member is sized and shaped to engage a rung of one of adjacent ladder sections of a ladder assembly. A generally rigid, elongate linear-output component has a longitudinal axis. A first longitudinal end margin is pivotally secured to the lever component and an opposite second longitudinal end margin. The linear-output component is pivotable relative to the lever component about a rotation axis that is generally transverse to the longitudinal axis of the lever component. The linear-output component includes a rung-engagement member at the second longitudinal end margin that is sized and shaped to engage a rung of another of the adjacent ladder sections. The lever component and the linear-output component are arranged so that when the rung-engagement members are engaging the rungs of the respective ladder sections, pivoting the lever component toward the linear output member imparts a linear force through the rung-engagement members that separates the ladder sections.

In another aspect, a ladder assembly kit generally comprises a ladder assembly including a plurality of longitudinal sections removably securable to one another. Each longitudinal ladder section includes a pair of opposing stiles and rungs extending between the stiles. A separating tool generally comprises a generally rigid, elongate lever component having a longitudinal axis and opposite longitudinal end margins. The lever component includes a rung-engagement member at one of the longitudinal end margins of the lever component and a handle generally adjacent to the other longitudinal end margin of the lever component. The rung-engagement member is sized and shaped to engage a rung of one of adjacent ladder sections of a ladder assembly. A generally rigid, elongate linear-output component has a longitudinal axis. A first longitudinal end margin is pivotally secured to the lever component and an opposite second longitudinal end margin. The linear-output component is pivotable relative to the lever component about a rotation axis that is generally transverse to the longitudinal axis of the lever component. The linear-output component includes a rung-engagement member at the second longitudinal end margin that is sized and shaped to engage a rung of another of the adjacent ladder sections. The lever component and the linear-output component are arranged so that when the rung-engagement members are engaging the rungs of the respective ladder sections, pivoting the lever component toward the linear output member imparts a linear force through the rung-engagement members that separates the ladder sections.

### BRIEF DESCRIPTION OF THE DRAWINGS

FIG. 1 is a perspective of a separating tool for separating sections of a ladder;

FIG. 2A is a side elevational view of the tool with a linear-output component of the tool in a retracted position;

FIG. 2B is a side elevation similar to FIG. 2A but with the linear-output component in an extended position;

FIG. 3 is a perspective of the separating tool in an initial position engaging sections of a ladder before the ladder sections are separated by the tool; and

FIG. 4 is a perspective similar to FIG. 3 but with the separating tool in a final position after the ladder sections have been separated by the separating tool.

Corresponding reference characters indicate corresponding parts throughout the drawings.

### DETAILED DESCRIPTION OF THE DRAWINGS

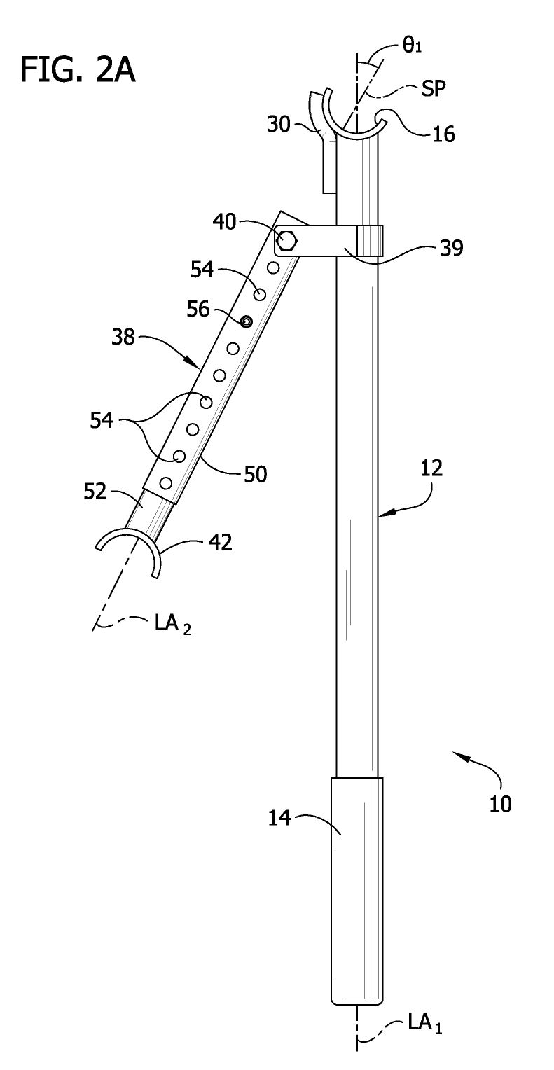

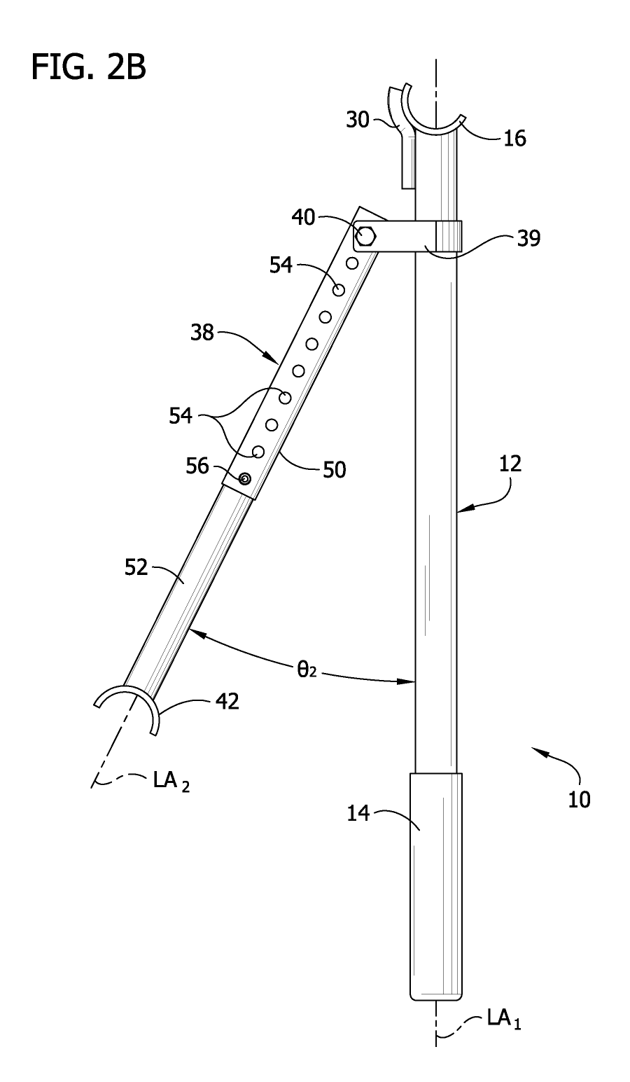

Referring now to the drawings, a separating tool for separating ladder sections of a ladder is generally indicated at 10. In general, the separating tool transfers a rotational force to a linear force applied along a length of the ladder to separate the sections of the ladder. The separating tool 10 includes a rigid, elongate lever component, generally indicated at 12, having a longitudinal axis LA₁ (FIGS. 2A and 2B) and a generally circular cross-section. A proximal end margin of the lever component 12 has a grip 14 to be used as a handle during operation. A first rung-engagement member 16 is disposed at a distal end of the lever component 12. As used herein, the terms “proximal” and “distal” are not meant in a limiting sense, but are instead used for convenience to describe the relative locations of structure with a point of origin being a hand of a user as properly situated on the grip 14 during use.

The first rung-engagement member 16 is generally C-shaped or semi-circular although it may have other shapes within the scope of the invention. The first rung-engagement member 16 is sized and shaped to engage a rung of a ladder assembly. For reasons explained below, the first rung-engagement member 16 is non-symmetrical about the longitudinal axis LA₁ of the lever component 12. Instead, the first rung-engagement member 16 has an imaginary symmetrical plane SP (FIG. 2B) extending at an angle θ₁ with respect to the longitudinal axis LA₁ of the lever component 12. As an example and without being limiting, the angle θ₁ may measure between about 30 degrees and about 60 degrees, and more particularly, about 45 degrees as in the illustrated embodiment. The first rung-engagement member 16 is secured to the distal end of the lever component 12, such as by welding or other suitable ways. In the illustrated embodiment, an elongate reinforcing member 30 is welded or otherwise secured to the first rung-engagement member 16 and the distal end margin of the lever component 12 to provide additional support to the first rung-engagement member and to ensure that the first rung-engagement member does not break away from the lever component during use. It is understood that the lever component 12 and the first rung-engagement member 16 may be constructed in other ways, such as being formed as one-piece.

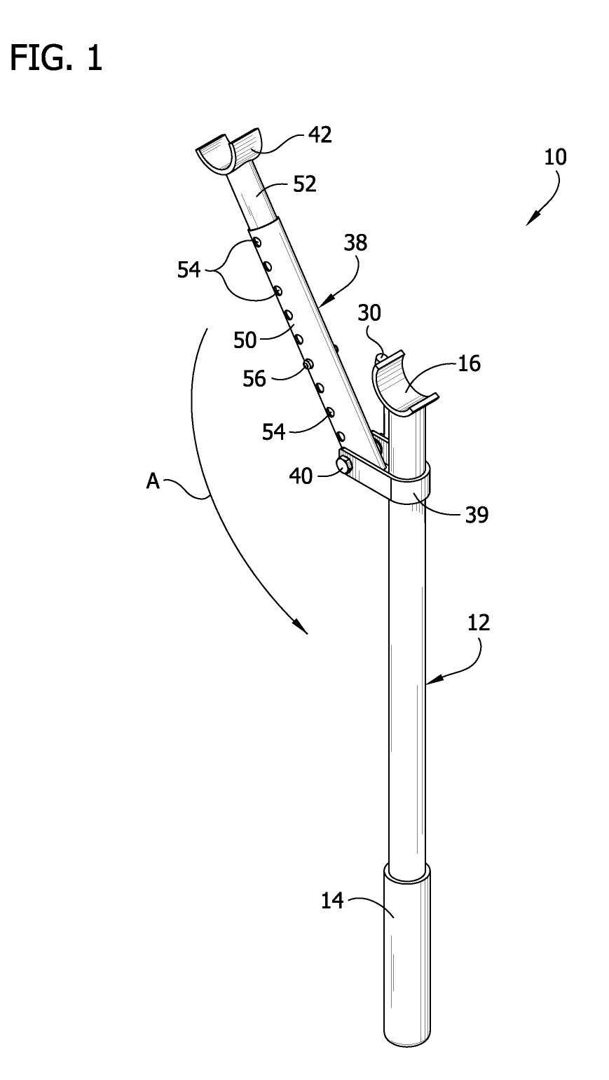

A linear-output component, generally indicated at 38, is pivotally secured to the lever component 12 using a clevis fastener 39. The clevis fastener 39 extends laterally outward from the lever component 12 generally adjacent to the distal end of the lever component. The clevis fastener 39 may be secured to the lever component 12 by welding, although other ways of securing the clevis fastener to the lever component are within the scope of the present invention. The linear-output component 38 is generally rigid and elongate and has a longitudinal axis LA₂ extending between an attached end and a free end. An attached end margin of the linear-output component 38 is pivotally secured to the clevis fastener 39 using a clevis pin 40 (e.g., a bolt) extending through the clevis fastener and the linear-output component. The linear-output component 38 is pivotable relative to the lever component 12 about an axis of the pin 40 (broadly, a rotational axis) that extends generally transverse to the longitudinal axis LA₁ of the lever component so that the linear-output component is pivotable toward and away from the lever component, as shown by the arrow A in FIG. 1. A second rung-engagement member 42 is secured to the free end of the linear-output component 38. The second-rung engagement member 42 is generally C-shaped or semi-circular although it may have other shapes within the scope of the invention. The second-rung engagement member is generally symmetrical about the longitudinal axis LA₂ of the linear-output component 38. The second rung-engagement member 42 is sized and shaped to engage a rung of a ladder.

For reasons explained below, the linear-output component 38 is selectively adjustable to different incremental lengths. In the illustrated embodiment, the linear-output component 38 includes a first segment 50 that is attached to the lever component 12, and a second segment 52, which includes the second rung-engagement member 42. The first segment 50 is tubular or hollow and the second segment 52 is telescopingly received in the first portion. The first segment 50 includes incrementally spaced openings 54 along its length for receiving a releasable, spring-biased locking pin 56 extending radially outward from the second segment 52. To adjust the length of the linear-output component 38, the pin 56 is depressed radially inward against the bias of a spring (not shown) to release it from engagement with the respective opening 54 of the first segment 50. The second segment 52 is slid axially to a different selected position, and the pin 56 is allowed to extend through the selected opening at the selected position to lock the linear-output component and prohibit telescoping movement between the first and second segments.

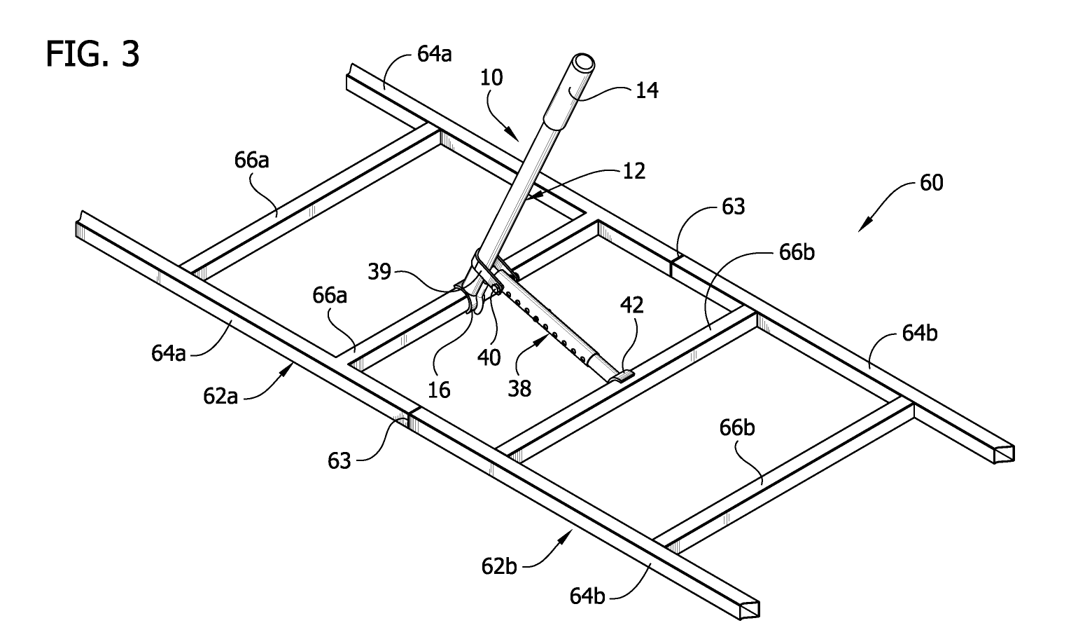

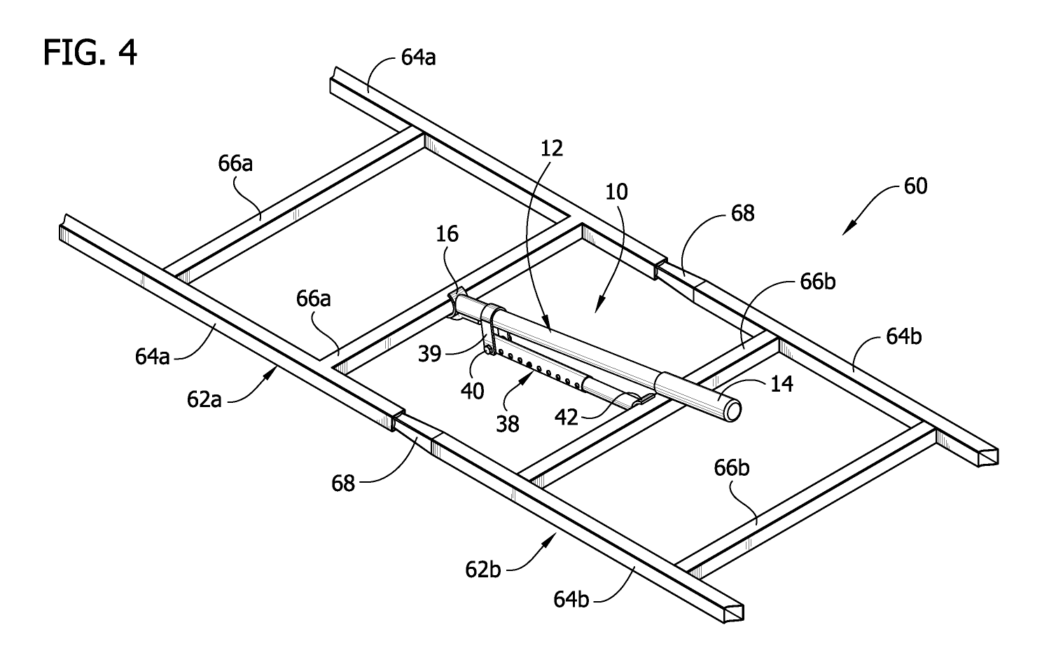

Referring now to FIGS. 3 and 4, an exemplary ladder assembly is generally indicated at 60. The ladder assembly includes two (or more) ladder sections, generally indicated at 62a, 62b, respectively, that are secured together at a securement location 63. Each of the ladder sections 62a, 62b includes generally parallel, opposing stiles 64a, 64b and rungs 66a, 66b secured to and extending between the stiles. The ladder sections 62a, 62b are secured together by a friction fit, press-fit or like at the securement locations 63 (FIG. 3). For example, in the illustrated embodiment (FIG. 4) the ladder assembly 60 is assembled by inserting swaged ends 68 of the stiles 64b of the ladder section 62b into respective open free ends of the stiles 64a of the other ladder section 62a.

Referring to FIG. 3, at an initial step to disconnect the ladder sections 62a, 62b, the ladder 28 may be laid on a horizontal surface. The lever component 12 is positioned so that the first rung-engagement member 16 engages the rung 66a of one of the ladder sections 62a that is adjacent to the securement location 63. The linear-output component 38 is positioned so that second rung-engagement member 42 engages the rung 66b of the ladder section 62b that is adjacent to the securement location 63. The linear-output component 38 may be pivoted about the axis of the pin 40 to properly position the second rung-engagement member 42 on the rung 66b.

With the first and second rung-engagement members 16, 42, respectively, engaging the respective rungs 66a, 66b, the length of the linear-output component 38 is selectively adjusted (i.e., either shortened or lengthened) so that the lever component 12 is extending at an angle θ2 (FIG. 2B) with respect to the linear-output component 38 that is suitable for producing enough leverage and enough linear movement of the linear-output component (e.g, about 0.25 inches) to separate the ladder sections 62a, 62b and break any fixed interconnection between them. For example, the angle θ2 is preferably between about 30° and 90°.

With the lever component 12 extending from the linear-output component 38 at the suitable angle θ2, the user grasps the handle 14 and exerts a downward force (i.e., toward the ladder) on the proximal end of the lever component. The downward force pivots the lever component 12 on the pin 40 connecting it to the linear-output component 38. This movement has the effect of pushing the rung engagement members 16 and 42 apart from each other, thereby pushing the rungs 66a, 66b apart from each other. The rung engagement members 16, 42 permit some relative rotational movement between the rung engagement members and the respective rungs 66a, 66b. The offset of the symmetrical plane SP of the first rung-engagement member 16 with respect to the longitudinal axis LA1 of the lever component allows the first rung-engagement member to fully engage a surface of the rung 66a that opposes the rung 66b of the other ladder section 62b so that the rung-engagement member maintains engagement with the rung as it pivots relative to the rung with movement of the lever component 12. This arrangement also ensures that a majority of the force being applied to the rung 66a engaged by the lever component 12 is directed linearly away from the opposing rung 66b on the other ladder section 62b. The user continues to apply downward force to the handle 14 of the lever component 12, continuing to impart linear force to the rungs 66a, 66b of the ladder sections 62a, 62b along the length of the ladder 60, until the ladder sections separate (FIG. 4). After separation of the two ladder sections 66a, 66b, the steps are repeated to separate any other attached ladder sections (not shown) of the ladder assembly 60.

Having described the illustrated embodiment(s) in detail, it will be apparent that modifications and variations are possible without departing from the scope of the invention defined in the appended claims.

When introducing elements of the present invention or the illustrated embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A separating tool for breaking down a ladder assembly of the type including adjacent ladder sections releasably secured to one another at longitudinal ends of the sections, the ladder sections including rungs, the tool comprising:
a generally rigid, elongate lever component having a longitudinal axis and opposite longitudinal end margins, the lever component including a rung-engagement member at one of the longitudinal end margins of the lever component and a handle generally adjacent to the other longitudinal end margin of the lever component, the rung-engagement member being sized and shaped to engage a rung of one of the adjacent ladder sections;
a generally rigid, elongate linear-output component having a longitudinal axis, a first longitudinal end margin pivotally secured to the lever component and an opposite second longitudinal end margin, the linear-output component being pivotable relative to the lever component about a rotation axis that is generally transverse to the longitudinal axis of the lever component, the linear-output component including a rung-engagement member at the second longitudinal end margin that is sized and shaped to engage a rung of the other of the adjacent ladder sections,
wherein the lever component and the linear-output component are arranged so that when the rung-engagement members are engaging the rungs of the respective ladder sections, pivoting the lever component toward the linear output member imparts a linear force through the rung-engagement members that separates the ladder sections.

2. A separating tool as set forth in claim 1 wherein each rung-engagement member defines a generally C-shaped channel.

3. A separating tool as set forth in claim 2 wherein the rung-engagement member of the lever component has an imaginary symmetrical plane that extends at an angle with respect to the longitudinal axis of the lever component.

4. A separating tool as set forth in claim 3 wherein the angle at which the symmetrical plane extends with respect to the longitudinal axis of the lever component measures between about 30 degrees and about 60 degrees.

5. A separating tool as set forth in claim 1 wherein the lever component includes a clevis fastener pivotally securing the first longitudinal end of the linear-output component to the lever component.

6. A separating tool as set forth in claim 1 wherein at least one of the lever component and the linear-output component has an adjustable length.

7. A separating tool as set forth in claim 6 wherein the linear-output component comprises a first segment defining the first longitudinal end margin pivotally secured to the lever component, and a second segment defining the second longitudinal end margin to which the rung-engagement member is secured, wherein the second segment is adapted for telescoping movement relative to the first segment.

8. A separating tool as set forth in claim 7 wherein one of the first segment and the second segment of the linear-output component includes a plurality of radial openings along its length, and wherein the other of the first component and the second component includes a retractable pin extending radially from the second component for removable reception in one of said plurality of openings.

9. A ladder assembly kit comprising:
a ladder assembly including a plurality of longitudinal sections removably securable to one another, each longitudinal ladder section including a pair of opposing stiles and rungs extending between the stiles;
a separating tool for separating adjacent longitudinal ladder sections of the ladder assembly, the separating tool comprising
a generally rigid, elongate lever component having a longitudinal axis and opposite longitudinal end margins, the lever component including a rung-engagement member at one of the longitudinal end margins of the lever component and a handle generally adjacent to the other longitudinal end margin of the lever component, the rung-engagement member being sized and shaped to engage a rung of one of the adjacent ladder sections;
a generally rigid, elongate linear-output component having a longitudinal axis, a first longitudinal end margin pivotally secured to the lever component and an opposite second longitudinal end margin, the linear-output component being pivotable relative to the lever component about a rotation axis that is generally transverse to the longitudinal axis of the lever component, the linear-output component including a rung-engagement member at the second longitudinal end margin that is sized and shaped to engage a rung of the other of the adjacent ladder sections,
wherein the lever component and the linear-output component are arranged so that when the rung-engagement members are engaging the rungs of the respective ladder sections, pivoting the lever component toward the linear output member imparts a linear force through the rung-engagement members that separates the ladder sections.
